(19) United States
(12) Patent Application Publication
(10) Pub. No.: US 2005/0215096 A1
(43) Pub. Date: Sep. 29, 2005

(54) Audio video jack provided with a defense wall

(75) Inventor: Masanori Sakata, Takefu-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Takefu-city (JP)

(21) Appl. No.: 11/085,045

(22) Filed: Mar. 22, 2005

(30) Foreign Application Priority Data
Mar. 26, 2004 (JP) 2004-091915

(51) Int. Cl. H01R 13/44

(52) U.S. Cl. 439/135

(57) ABSTRACT

The present invention was made considering these problems, and has the objective of providing an audio-video jack provided with a defense wall which prevents a foreign object such as a wire from being inserted through the tip of the audio-video jack from the outside and penetrating to the back of the audio-video jack.

An audio-video jack 1 has a terminal unit 2. A housing 6 installed as a single unit with the terminal unit 2 is installed on one end of the terminal unit 2. A defense wall 10 is installed on the rear section of the housing 6, and when a foreign object such as a wire is inserted from the terminal unit 2 of the audio-video jack 1, it blocks a foreign object from penetrating to the back of the audio-video jack 1. Thus, when audio-video equipment provided with the audio-video jack 1 is powered, because the insertion of a foreign object into the interior of the audio-video equipment is prevented, electric shock from touching various kinds of devices is prevented, making it superior in terms of safety.

The present application is based on and claims priority of Japanese patent application No. 2004-091915 filed on Mar. 26, 2004, the entire contents of which are hereby incorporated by reference.

### BACKGROUND OF THE INVENTION

1. Field of the Invention

The present invention relates to an audio-video jack installed in audio-video equipment, where audio and video signals are input/output, and especially relates to an audio-video jack provided with a defense wall which prevents electric shock or damage to various parts built into audio-video equipment from being caused by a child or someone mischievously inserting an electro-conductive foreign object, such as a wire, from the front of the audio-video jack to which a connection plug is connected, installed at the ends of a connection cable, in which a wire touching a device such as audio-video equipment could potentially cause electric shock, for example.

2. Description of the Related Art

Generally jacks are installed in various kinds of electronic equipment, such as conventionally used audio-video equipment, for attaching connection cables and/or earphones for the external input/output of audio and/or video signals for the electronic equipment.

However, much electronic equipment targets adult users and is not provided to users, such as children, who might misuse the electronic equipment, for example. It cannot be denied that if it not used as intended, the unexpected might occur, putting the electronic equipment out of order, or inducing electric shock if the electronic equipment is powered, for example, from a household-use power supply. In order to solve such problems, disclosed in Patent Document 1 is an example where a barrier substrate is placed behind a jack to prevent a foreign object, such as a pin, from being inserted into the jack and touching the primary power supply primary located behind it, in order to prevent anything from touching the primary power supply comprising the primary electrified section of a power supply board built into the electronic equipment.

Patent Document 1:

Japanese Laid-Open Utility Model Application H 05-23463

### SUMMARY OF THE INVENTION

The present invention was made considering the problems referred to above, and has the objective of providing an audio-video jack provided with a defense wall installed behind the audio-video jack installed in AV (audio-video) equipment to prevent a foreign object, such as a wire, from being externally inserted and penetrating the backside of the audio-video jack.

The audio-video jack provided with the defense wall of claim 1 is characterized by the fact that, in an audio-video jack provided with an tubular external connector wrapped with an electro-conductive conductor on the face of its outer circumference, an insulating inner circumference section formed on the inner circle of the external connector, an electro-conductive protrusion which protrudes from the insulating inner circumference section, and a housing where a void penetrating in the front-back direction is installed as a single unit with the external connector at one end in the axial direction, a defense wall to prevent the insertion of foreign bodies is installed on the back of the housing.

According to the construction of claim 1, even if a foreign object, such as a wire, is inserted into the void of the housing from the tip of the tubular external connector, because a defense wall is installed to the rear of the housing, it can be securely shielded from the insertion of a foreign object. Hence, when the audio-video jack is attached to the chassis of audio-video equipment, for example, even if an attempt is made to insert a foreign object, such as a wire, into audio-video equipment from the audio-video jack, electric shock from touching a device or part charged with a high voltage installed inside the audio-video equipment can be prevented, providing superior safety.

The audio-video jack provided with the defense wall of claim 2 is characterized by the fact that, in an audio-video jack provided with the defense wall described in claim 1, the defense wall comprises a metallic bent piece installed as a single unit with the housing.

According to the construction of claim 2, because the bent piece is made of low-cost metal, an inexpensive audio-video jack can be provided. Also, because the bent piece is made of metal, it has plasticity, and bending of the bent piece can be performed easily.

The audio-video jack provided with the defense wall of claim 3 is characterized by the fact that, in an audio-video jack provided with the defense wall described in claim 1, the defense wall is formed as a single unit on the rear section of the housing.

According to the construction of claim 3, because the housing and the defense wall are formed as a single unit, where the housing and the defense wall can be formed together using a metal mold, time spent in the manufacturing process can be reduced.

The audio-video jack provided with the defense wall of claim 4 is characterized by the fact that, in an audio-video jack provided with the defense wall described in claim 1, a hooking hole is formed on the housing and a hook which hooks onto the hooking hole is installed as a single unit with the defense wall.

According to the construction of claim 4, the defense wall can be attached to be freely-detachable to the housing by hooking the hook of the defense wall onto the hooking hole of the housing.

The audio-video jack provided with the defense wall of claim 5 is characterized by the f act that, in an audio-video jack provided with the defense wall described in one of claims 1˜4, a plurality of the audio-video jacks is serially installed as a single unit in the horizontal direction perpendicular to the axial direction of the external connector.

According to the construction of claim 5, because a plurality of audio-video jacks are installed in the horizontal direction, when the audio-video jack needs to be attached to the back or front of the low-profile type audio-video equipment which has become popular in recent years, the audio-video jacks to be serially installed in the horizontal direction can be installed within the height of the audio-video equipment, even if it is a low-profile, thin-type audio-video equipment.

According to the invention of the audio-video jack provided with the defense wall of claim 1, in an audio-video jack provided with a tubular external connector where an electro-conductive conductor having conductivity on its outer circumference is externally installed, with an insulating inner circumference section formed on the inner circumference of the external connector, an electro-conductive protrusion piece having conductivity which protrudes from the insulating inner circumference section, and a housing where a void penetrating in the front-back direction is installed as a single unit with the external connector at one end in the axial direction, because a defense wall is installed on the rear section of the housing to prevent the insertion of foreign bodies, even if a foreign object such as a wire is inserted into the audio-video jack, because the defense wall is installed in the audio-video jack, when the audio-video equipment provided with the audio-video jack is powered, for example, a conductive foreign object, such as a wire, can be prevented from inadvertently being inserted into the interior of the audio-video equipment or by a child. Hence, it is superior in safety because electric shock caused by touching a device or part charged with high voltage installed within the audio-video equipment can be prevented.

According to an audio-video jack provided with the construction of claim 2, because the defense wall comprises a bent piece made of metal installed as a single unit with the housing in claim 1, by using a bent piece made of inexpensive metal, an inexpensive audio-video jack can be provided. Also, because the bent piece is made of metal, bending the bent piece can be easily done, and productivity improved.

According to the invention of an audio-video jack provided with the defense wall of claim 3, because the defense wall is formed as a single unit on the rear of the housing and the housing and the defense wall can be formed together in claim 1, manufacturing time can be reduced, productivity improved. Furthermore, because the defense wall is formed on the rear of the housing, it can be easily checked to confirm if the audio-video jack has a defense wall installed.

According to the invention of an audio-video jack provided with the defense wall of claim 4, a hooking hole is formed on the housing, and a hook which hooks onto this hooking hole is installed as a single unit with the defense wall in claim 1. Because the defense wall can be easily attached to be freely-detachable from the housing, workability is improved.

According to the invention of an audio-video jack provided with the defense wall of claim 5, in one section described in claims 1˜4 a plurality of the audio-video jacks are horizontally serially installed as a single unit in the direction perpendicular to the axial direction of the external connector, and because even low profile audio-video equipment can be placed within the height of the audio-video equipment, it is superior in general usability.

### BRIEF DESCRIPTION OF THE DRAWINGS

FIG. 1 is a front view showing the state where the audio-video jack in Embodiment 1 is attached.

FIG. 2 is a side view of the same audio-video jack as the above.

FIG. 3 is a plane view of the same audio-video jack as the above.

FIG. 4 is rear view of the same audio-video jack as the above.

FIG. 5 is a plane view of the audio-video jack where a housing and a defense wall are installed as a single unit in Embodiment 2.

FIG. 6 is a side view of the audio-video jack where a housing and a defense wall are installed as a single unit in Embodiment 3.

FIG. 7 is a front view showing the state where a plurality of audio-video jacks are installed in a series as a single unit in the horizontal direction in Embodiment 4.

### DETAILED DESCRIPTION OF THE PREFERRED EMBODIMENTS

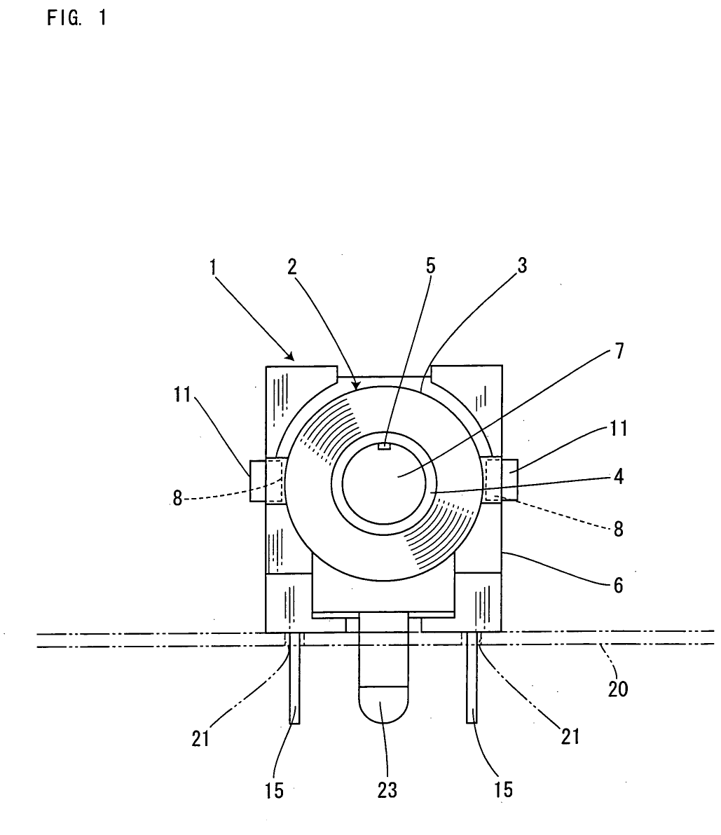

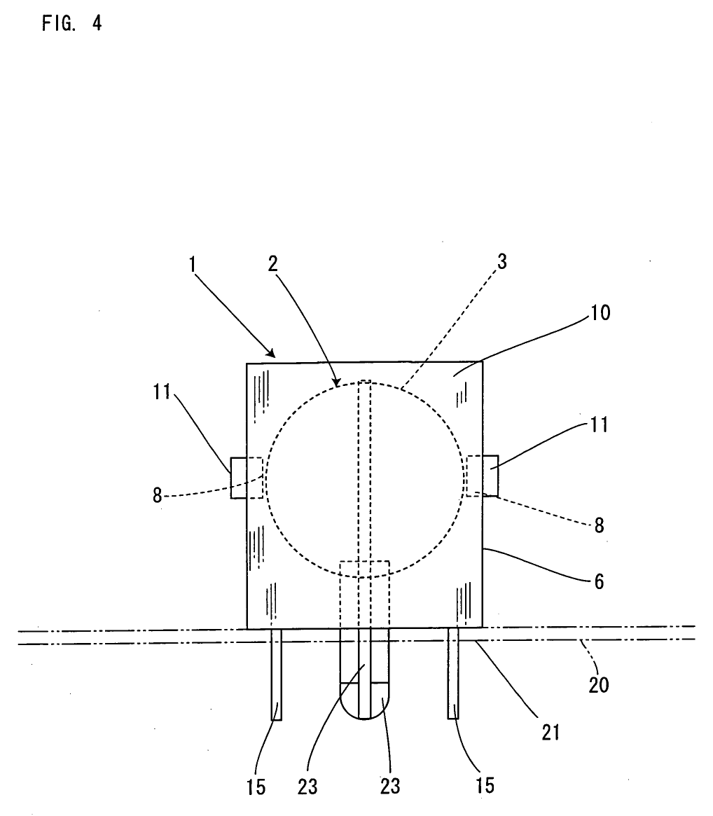

Preferred embodiments of the invention are explained hereafter with reference to FIGS. 1-7. It goes without saying that the present invention can be easily applied to constructions other than those explained in the embodiments, within the range that does not contradict the purpose of the invention.

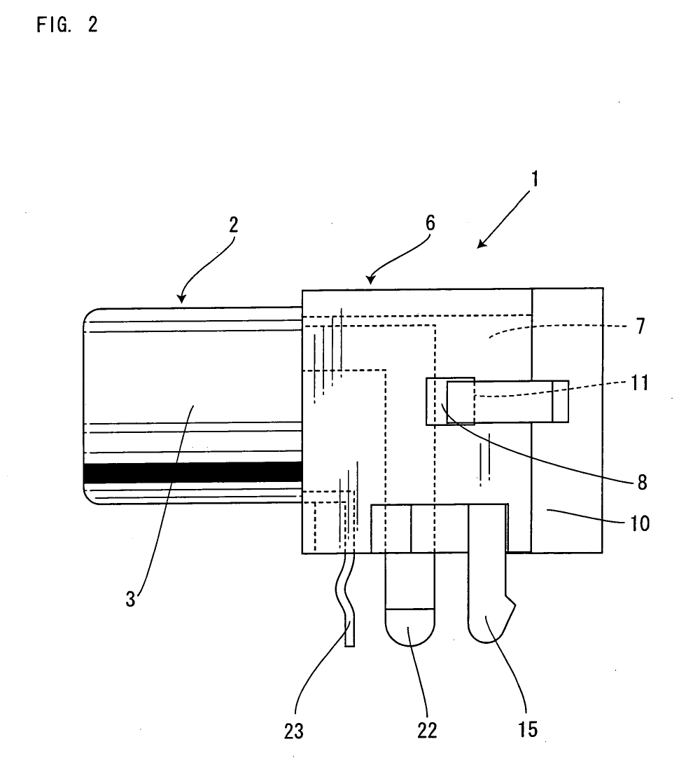

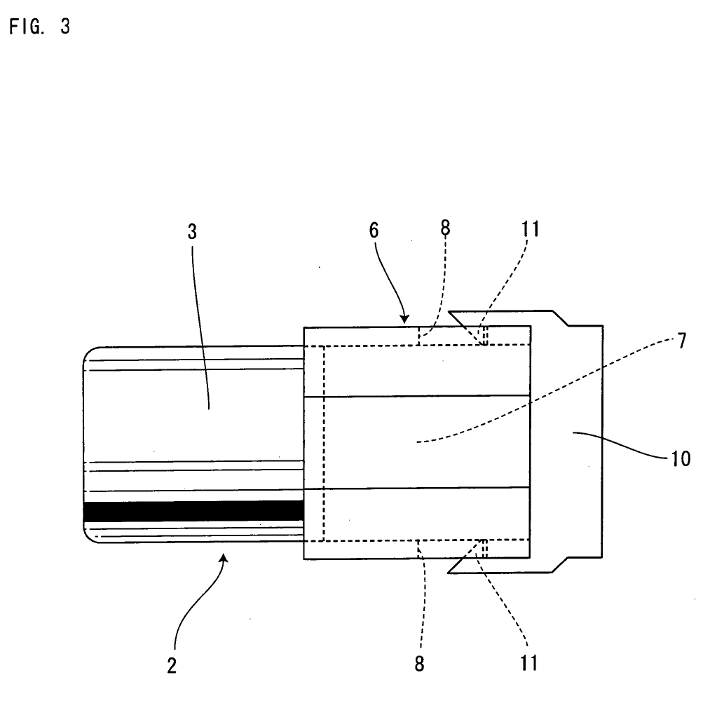

FIG. 1 is a front view of an audio-video jack 1 in the present embodiment, FIG. 2 is a side view of the audio-video jack, and FIG. 3 is a plane view of the audio-video jack.

As shown in the figures, the audio-video 1 is provided with an overall tubular terminal unit 2, which is provided with a tubular external connector 3 where a conductor, the outer surface of which is conductive is installed externally. Also, on the circumference face within the external connector 3 is an installed insulating inner circumferential section 4 made of synthetic resin having insulating properties, and a conductive protrusion 5 which protrudes further toward the interior from the insulating inner circumferential section 4.

A housing 6 made of synthetic resin is installed as a single unit on one end in the axial direction of the terminal unit 2. Within the housing 6 is an installed void 7 penetrating in the front to back direction (the horizontal direction shown in FIG. 2), and formed on the side sections of the housing 6 are a pair of opposing hooking holes 8 and 8 where the hooks of a defense wall, described hereafter, are hooked.

Indicated as 10 is a plate-shaped defense wall attached to be freely-detachable to the rear section of the housing 6. When a foreign object such as a wire is inserted from the terminal unit 2 of the audio-video jack 1, it blocks the penetration of a foreign object penetrates to the rear of the audio-video jack. As shown in FIG. 3, installed in this defense wall 10 are a pair of hooks 11 and 11 which are hooked as a single unit with the defense wall 10 to the pair of hooking holes 8 and 8. The rear section of the housing 6 is completely blocked without any space with the defense wall 10 by hooking the hooks 11 and 11 to the hooking holes 8 and 8. On the other hand, the terminal unit 2 is crimp installed as a single unit to the front section of the housing 6. In this way, in the state where the terminal unit 2 is installed in the front section of the housing 6, the front side of the audio-video jack 1 is formed so that no dust can enter from the outside except for the center in the axial direction of the terminal unit 2.

Also, interlocking protrusions 15 and 15 protruding downwards from the housing 6 are installed as a single unit with the housing 6 on the lower end of the housing 6, the interlocking protrusions 15 and 15 being inserted into a hole section 21 formed on a circuit board 20 or audio-video equipment so that the audio-video jack 1 is fixed, the terminal unit 2 being placed so as to protrude from the chassis of the audio-video equipment.

Also, installed in the void 7 of the housing is an electro-conductive first conductor plate 22 which is connected to the external connector 3, the tip of the first conductor plate 22 being installed protruding downwards from the void 7 of the housing 6. Also, the protrusion 5 which protrudes slightly from the connector inner circumference face 4 is connected with a second conductor plate 23, and the tip of the second conductor plate 23 is installed protruding downwards from the void 7 of the housing 6 in the same way as in the external connector 3. In this manner, the audio-video jack 1 in the present embodiment has a bi-polar structure having two electrodes through which the tips of the first and second conductor plates 22 and 23 are connected by soldering to a circuit pattern of the circuit board 20, etc.

As with the above, according to the present embodiment, the audio-video jack 1 is provided with a tubular external connector 3 where a conductor, the outer circumferential face of which electro-conductive, is externally installed, with an insulating inner circumference section 4 formed on the inner circumference of the external connector 3, a protrusion 5 having conductivity which protrudes from the insulating inner circumference section 4, and a housing 6 where a void 7 penetrating in front to back direction is installed as a single unit with the external connector 3 at one end in the axial direction, a defense wall 10 being installed on the rear section of the housing 6 to prevent the insertion of foreign bodies. Even if a foreign object such as a wire is inserted from outside of the audio-video jack 1 to the void 7 of the housing 6 through the tip side (left side shown in FIG. 2) of the tube-type external connector 3, because the defense wall 10 is installed on the rear section of the housing 6, insertion of the foreign object can be securely blocked. Hence, if the audio-video jack 1 is attached to the chassis of the audio-video equipment, for example, even an attempt is made to insert a foreign object such as a wire carelessly through the audio-video jack 1 to the interior of the audio-video equipment, electric shock caused by touching a device or part charged with a high voltage installed inside the audio-video equipment can be prevented. Hence it is superior in terms of safety. Furthermore, because the hooking holes 8 and 8 are formed on the housing 6, and the hooks 11 and 11 which hook to these hooking holes 8 and 8 are installed as a single unit with the defense wall 10, by hooking the hooks 11 and 11 of the defense wall 10 to the hooking holes 8 and 8 of the housing 6, the defense wall 10 can be attached to be freely-removable from the housing 6, making the attachment easy with improved workability.

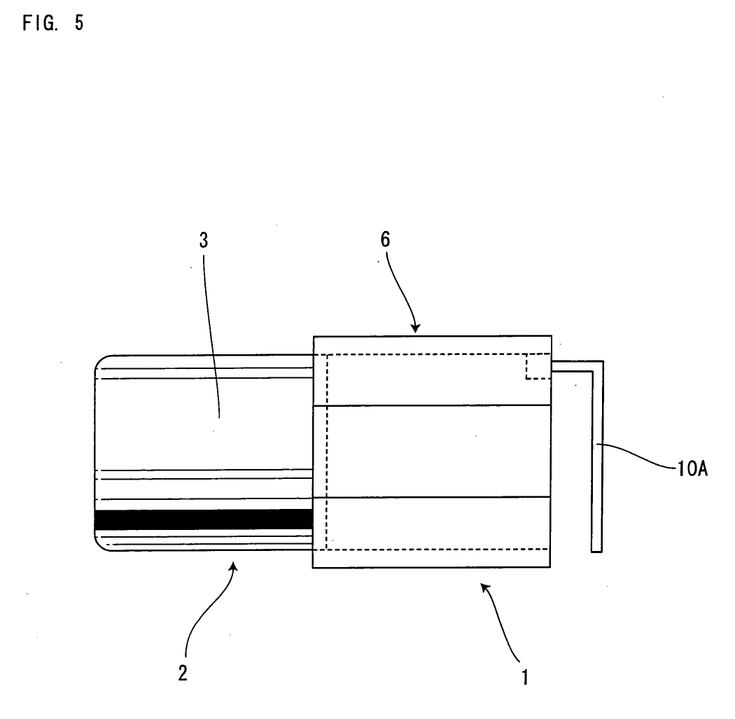

FIG. 5 is a plane view of the audio-video jack 1 showing an Embodiment 2 of the present invention, where the same codes are assigned to the same parts as in the Embodiment 1, and the detailed explanations of which are omitted. As shown in FIG. 1, a defense wall 10 is installed as a single unit with a housing 6 on the rear section of the housing 6 of the audio-video jack 1 of Embodiment 1, and a bent piece 10A is attached as the defense wall of Embodiment 2 by inserting it to a fitting section, not shown inside the housing 6, forming one unit with the housing 6 while remaining away from the rear section of the housing. Because the bent piece 10A is made of low-cost metal as its raw material, by the ability to install a defense wall to the audio-video jack at low cost, an inexpensive audio-video jack can be provided. Also, because the bent piece is metallic, and has plasticity, bending the bent piece can be performed easily, with improved productivity. Also, because the bent piece 10A is installed on the rear section of the housing 6 in Embodiment 2 in the same way as in Embodiment 1, insertion of foreign bodies can be securely blocked. Hence, if the audio-video jack 1 is attached to the chassis of audio-video equipment etc. for example, even if an attempt is made to insert a foreign object such as a wire to the interior of the audio-video equipment through the audio-video jack 1 by carelessness, electric shock caused by touching a device or part charged with high voltage installed inside the audio-video equipment can be prevented, making it superior in safety.

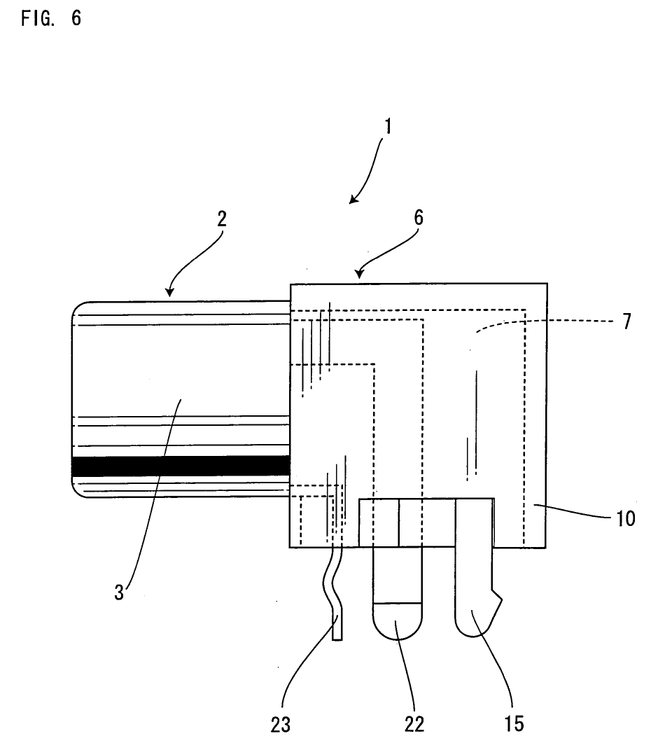

Shown in FIG. 6 is Embodiment 3 of the present invention, where the same codes are assigned to the same parts as in the Embodiment 1, and their detailed explanations are omitted. As shown in FIG. 6, the audio-video jack 1 in Embodiment 3 has a defense wall 10B formed on the rear of the housing as a single unit with the housing. Because the housing 6 and the defense wall 10B are formed as a single unit, the housing 6 and the defense wall 10B can be simultaneously formed by injection molding, reducing time spent in the manufacturing process and improving the productivity. Furthermore, because the defense wall 10B is formed on the rear of the housing 6, it can be easily checked visually to determine whether the audio-video jack 1 has the defense wall 10B installed. Because, in Embodiment 3, the housing 6 and the defense wall 10B are installed as a single unit in the same way as in Embodiment 1, insertion of a foreign object can be securely blocked. Hence, if the audio-video jack 1 is attached to the chassis of the audio-video equipment, for example, even if an attempt is made to insert a foreign object such as a wire carelessly, because electric shock caused by touching a device or part charged with high voltage installed inside the audio-video equipment can be prevented, it is superior in terms of safety.

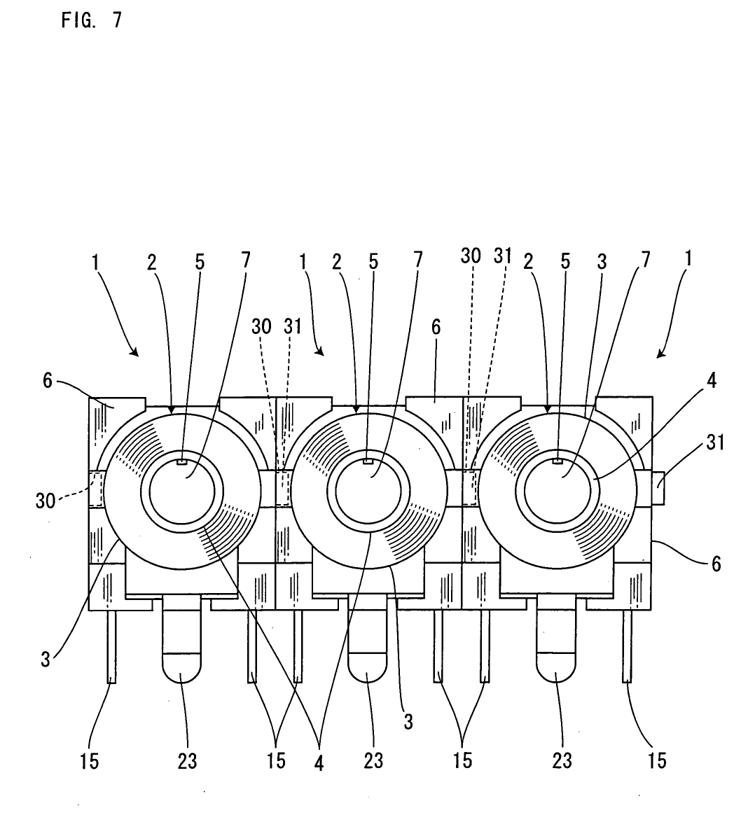

Embodiment 4 of the present invention is shown in FIG. 7, where the same codes are assigned to the same parts as in the Embodiment 1, and the detailed explanations of which are omitted. The audio-video jack in Embodiment 4 has a plurality of audio-video jacks 1, 1, and 1 serially installed as a single unit in the horizontal direction perpendicular to the axial direction of the external connector 2 in an audio-video jack in Embodiments 1˜4, as shown in FIG. 7. Specifically, a concave section 30 and a convex section 31 are formed on the sidewall of the housing 6, which can be assembled like blocks. By this means, a plurality of audio-video jacks 1, 1, and 1 are serially installed as a single unit in the horizontal direction, and even if it becomes necessary to attach the audio-video jacks 1, 1, and 1 on the back side or front side of low-profile audio-video equipment which is popular in recent years, because the audio-video jacks 1 are serially installed in the horizontal direction, even low profile thin audio-video equipment can be placed to fit within the height of the audio-video equipment, giving it superior usability, and because defense walls 10, 10A, and 10B on the rear section of the housing 6 in the same way as in the Embodiment 1 etc., insertion of a foreign object can be securely blocked. Hence, if a plurality of audio-video jacks 1 are attached to the chassis etc. of audio-video equipment for example, even an attempt is made to insert a foreign object such as a wire carelessly through the audio-video jacks 1, 1, and 1 to the interior of the audio-video equipment, because electric shock caused by touching a device or part charged with high voltage installed inside the audio-video equipment can be prevented, making it is superior in safety. Shown in FIG. 7 is an example where three audio-video jacks are serially installed, it is not especially limited to this number, but four or more audio-video jacks 1 may be installed, or they may be installed in parallel without a limitation to this number.

1. An audio video jack wherein, in an audio-video jack provided with:
a tubular external connector where a conductor having conductivity on its outer circumference face is externally installed,
an insulating inner circumference section formed on the inner circumferential face of the external connector,
an electro-conductive protrusion which protrudes from the insulating inner circumference section, and
a housing where a void penetrating in the front-back direction is installed as a single unit with the external connector at one end in the axial direction, wherein
a defense wall installed on the rear section of the housing to prevent the insertion of foreign bodies.

2. The audio-video jack provided with the defense wall described in claim 1, characterized by the fact that the defense wall comprises a metallic bent piece installed as a single unit with the housing.

3. The audio-video jack provided with the defense wall described in claim 1, characterized by the fact that the defense wall is formed as a single unit with the housing on the rear section.

4. The audio-video jack provided with the defense wall described in claim 1, characterized by the fact that a hooking hole is formed on the housing, wherein the hook which hooks to the hooking hole is installed as a single unit with the defense wall.

5. The audio-video jack provided with a defense wall described in claim 1, characterized by the fact that a plurality of audio-video jacks are serially installed as a single unit in the horizontal direction perpendicular to the axial direction of the external connector.

6. The audio-video jack provided with a defense wall described in claim 2, characterized by the fact that a plurality of audio-video jacks are serially installed as a single unit in the horizontal direction perpendicular to the axial direction of the external connector.

7. The audio-video jack provided with a defense wall described in claim 3, characterized by the fact that a plurality of audio-video jacks are serially installed as a single unit in the horizontal direction perpendicular to the axial direction of the external connector.

8. The audio-video jack provided with a defense wall described in claim 4, characterized by the fact that a plurality of audio-video jacks are serially installed as a single unit in the horizontal direction perpendicular to the axial direction of the external connector.
